(19) United States
(12) Patent Application Publication
(10) Pub. No.: US 2017/0080370 A1
(43) Pub. Date: Mar. 23, 2017

(54) Filter System and Filter Element Having a Glass Fiber Filter Medium and a Sintered Body

(71) Applicant: MANN+HUMMEL GMBH, Ludwigsburg (DE)

(72) Inventor: Lars Spelter, Ditzingen (DE)

(21) Appl. No.: 15/366,242

(22) Filed: Dec. 1, 2016

Related U.S. Application Data
(63) Continuation of application No. PCT/EP2015/062063, filed on Jun. 1, 2015.

(30) Foreign Application Priority Data
Jun. 2, 2014 (DE) 10 2014 007 813.2

(51) Int. Cl. B01D 39/20; B01D 39/16

(52) U.S. Cl. CPC B01D 39/2017; B01D 39/2034; B01D 39/1661; B01D 2239/065; B01D 2239/1291; B01D 2239/1216

(57) ABSTRACT

A filter system for filtering a fluid is provided with a filter housing and a filter element arranged in the filter housing. The filter element has a glass fiber filter medium. A sintered body is arranged fluidically downstream of the glass fiber filter medium for retaining constituents of the glass fiber filter medium entrained in a fluid to be filtered. A pore size of the sintered body is greater than a cross-section of the constituents of the glass fiber filter medium.

### CROSS-REFERENCE TO RELATED APPLICATIONS

This application is a continuation application of international application No. PCT/EP2015/062063 having an international filing date of 1 Jun. 2015 and designating the United States, the international application claiming a priority date of 2 Jun. 2014, based on prior filed German patent application No. 10 2014 007 813.2, the entire contents of the aforesaid international application and the aforesaid German patent application being incorporated herein by reference.

### BACKGROUND OF THE INVENTION

The invention concerns a filter system and a filter element for filtering a fluid. The filter system and the filter element are preferably usable in motor vehicles, in particular for filtering fuel.

U.S. Pat. No. 6,096,212 discloses a filter element for liquids and gases. The filter element comprises a filter medium that is arranged between two end disks of the filter element and that is folded, as is known in the art, in a star shape. The filter medium is designed as a sintered body which is comprised of a plurality of metal fibers.

EP 1 000 649 A1 discloses a water circuit with a filter stage. The filter stage comprises a cartridge with a blocking layer of sintered plastic material.

Moreover, DE 10 2011 003 645 A1 discloses a filter device for filtering a liquid of an internal combustion engine of a motor vehicle. The filter device comprises a filter housing and a filter element which is arranged in the filter housing. In order to reduce escape of residual dirt from an outlet of the filter housing in case of changing the filter element, in the area of the outlet an additional filter element is arranged. The additional filter element comprises a filter body of sintered metal.

Finally, filter systems and filter elements are known that comprise a glass fiber filter medium. Glass fiber filter media are chemically resistant and particularly efficient when filtering out foreign bodies, in particular when filtering out foreign bodies from fuels.

It is known that the glass fibers of such a glass fiber filter medium are hard and brittle. Upon installation of the glass fiber filter medium in a filter element or in operation of the filter system or of the filter element, glass fiber constituents can therefore become detached from the glass fiber filter medium and can contaminate the filtered fluid. In particular in case of high pressure injection of a fluid in the form of a fuel into a combustion chamber of a motor vehicle engine, such glass fiber parts or glass fiber fragments can cause damage of a high-pressure pump or of the injector.

For avoiding such a contamination of the fluid by glass fiber parts and damage of other components or component groups as a result thereof, an additional filter medium for retaining the possibly detaching constituents of the glass fiber filter medium could be provided, for example. For this purpose, the additional filter medium must however comprise, due to the sharp-edged constituents of the glass fiber medium, a sufficiently thick cellulose layer or finest synthetic fibers. An additional filter medium of such a construction increases however the flow resistance of the filter system or of the filter element in a disadvantageous way. Moreover, due to the additional filter element, the service life of the filter system or of the filter element can be reduced. Finally, errors in the processing of the additional filter medium, in particular during embossment and folding, may cause failure of the blocking function of the additional filter medium.

### SUMMARY OF THE INVENTION

It is therefore the object of the present invention to provide a filter system or a filter element that reliably retains constituents of a glass fiber filter medium of the filter system or of the filter element without having to integrate an additional layer into the filter medium.

The solution according to the invention in regard to the filter system comprises thus a filter system for filtering a fluid comprising a filter housing and a filter element arranged in the filter housing, wherein the filter element comprises a glass fiber filter medium and the filter system comprises a sintered body which is arranged fluidically downstream of the glass fiber filter medium for retaining constituents of the glass fiber filter medium in the fluid.

The dependent claims concern advantageous further embodiments of the filter system.

The solution according to the invention in regard to the filter element comprises a filter element comprising a glass fiber filter medium and a sintered body arranged fluidically downstream of the glass fiber filter medium for retaining constituents of the glass fiber filter medium entrained in the fluid.

The sintered body increases the flow resistance only insignificantly. Still, in case of detachment of a constituent of the glass fiber filter medium, this constituent will become wedged within the sintered body. Damage of a component arranged fluidically downstream of the filter system can thus be reliably prevented. In order to keep the flow resistance of the sintered body as low as possible, the pore size or the average pore size of the sintered body according to the invention is preferably greater than the cross-section of the constituents of the glass fiber filter medium that are to be retained. The pores can therefore have a clearance between 15 μm and 115 μm, in particular between 20 μm and 110 μm, preferably between 25 μm and 105 μm, particularly preferred between 30 μm and 100 μm.

The sintered body according to the invention can be flowed through in the direction of its longitudinal axis and/or transverse to its longitudinal axis. The sintered body in this context can be substantially of a parallelepipedal shape, disk-shaped or also tubular. In case of a disk-shaped or tubular sintered body, it can be flowed through preferably axially and/or radially.

The sintered body can be substantially embodied of plastic material or a plastic material mix. The plastic material or plastic material mix can comprise in addition a foreign matter additive. By use of the plastic material or a plastic material mix, the costs for producing the sintered body can be kept extremely low.

The sintered body can alternatively also be comprised substantially of metal. The metal, in particular stainless steel or bronze, can have in this context at least a minimal addition of foreign matter. The use of metal has the advantage that the pore size and the shape of the sintered body can be defined very precisely.

Moreover, the sintered body can be embodied of ceramic or substantially of ceramic. Sintered bodies of ceramic are chemically inert to the greatest possible extent and exhibit a great hardness.

In a preferred embodiment of the invention, the thickness of the sintered body in its flow direction is between 0.1 mm and 30 mm, in particular between 0.5 mm and 20 mm, preferably between 1 mm and 10 mm. The sintered body can thus be arranged in a space-saving way in the filter system.

A constructively simple and cost-efficient manufacture of the sintered body can be achieved when the sintered body comprises sintering beads. In this context, the sintering beads all have preferably substantially the same diameter. In this way, uniform defined pore sizes can be obtained.

The thickness of the sintered body in its flow direction can be greater than three times the average diameter of the sintering beads, in particular greater than four times the average diameter of the sintering beads, preferably greater than five times the average diameter of the sintering beads, particular preferred greater than six times the average diameter of the sintering beads. In other words, the sintered body in the flow direction comprises preferably several layers (more than 3, 4, 5, 6 . . . ) of sintering beads. The more layers the sintered body contains, the more effective the blockage of a detached constituent of the glass fiber filter medium becomes.

In a particularly preferred embodiment of the invention, the pores of the sintered body are arranged staggered relative to each other at least partially transverse to the flow direction. The rigid, detached constituents of the glass fiber medium are caught in this case particularly well in the pores or flow channels of the sintered body that overall are embodied or arranged in a “zigzag shape”. The pores or through openings in this case can have a clearance of a multiple of 10 μm. Since according to the Hagen-Poiseuille equation, the clearance to the fourth power is used in calculating the flow resistance, an enlargement of the clearance of the pores causes a drastic drop of the flow resistance. Such an arrangement can be achieved in a particularly simple and inexpensive way in that the sintered body comprises sintering beads which are arranged in the densest packing of spheres.

According to a preferred embodiment of the invention, the sintered body is integrated into a filter housing of the filter system. On the one hand, the sintered body can therefore be arranged in the filter system in a space-saving way. On the other hand, the sintered body can be exchanged individually after reaching the end of its service life, which, if need be, surpasses the service life of the filter element multiple times. Preferably, it is designed as a lifetime part and must not be exchanged when changing the filter element.

According to the invention, the sintered body can however also be integrated into the filter element, in particular into an end disk or a central tube of the filter element. In this case, the sintered body is mandatorily renewed also when exchanging the filter element.

The filter element according to the invention for filtering a fluid has a glass fiber filter medium and a sintered body arranged fluidically downstream of the glass fiber filter medium for retaining constituents of the glass fiber filter medium in the fluid.

According to the invention, the sintered body can be integrated in an end disk of the filter element. Alternatively, the sintered body can also be arranged in a central tube of the filter element.

The sintered body can have the afore described preferred features.

### BRIEF DESCRIPTION OF THE DRAWINGS

Further features and advantages of the invention can be taken from the following detailed description of several embodiments of the invention, from the Figures of the drawing showing important details of the invention, as well as from the claims.

The features illustrated in the drawing are illustrated such that the particularities of the invention can be made clearly visible. The different features can be realized individually by themselves or several combined in any combination in variants of the invention.

FIG. 1 shows a schematic side view of a filter system with a first filter element.

FIG. 2 shows a schematic side view of a second filter element.

FIG. 3 shows a schematic, greatly enlarged detail in perspective illustration of the sintered body according to FIG. 1.

### DESCRIPTION OF PREFERRED EMBODIMENTS

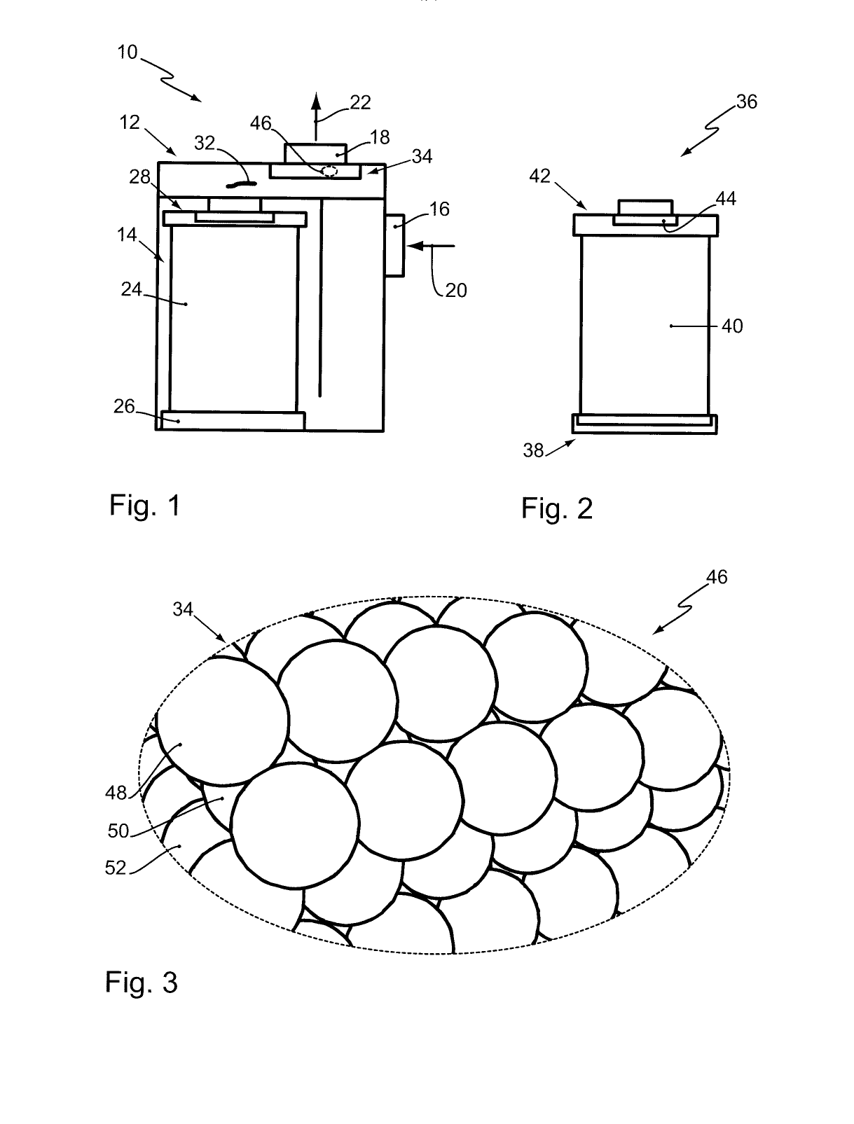

FIG. 1 shows a filter system 10 according to the invention. The filter system 10 comprises a filter housing 12. In the filter housing 12, an exchangeable first filter element 14 is arranged.

The filter housing 12 comprises an inlet 16 and an outlet 18 for a fluid to be filtered, in particular for fuel. The filter housing 12 can thus be flowed through, as indicated by arrows 20, 22, wherein the filtering action is substantially realized in the first filter element 14.

The first filter element 14 comprises a filter medium 24. The filter medium 24 is arranged between a first end plate 26 and a second end plate 28 of the filter element 14 and is designed as a glass fiber filter medium 24. Individual glass fibers can break out of the glass fiber filter medium 24 and can contaminate the fluid. The constituent 32 of the glass fiber filter medium 24 is illustrated particularly large in FIG. 1 for illustration purposes. Realistic constituents 32 of the glass fiber filter medium 24 have in longitudinal direction a length of up to several millimeters and an (average) thickness, measured transverse to the longitudinal direction, of a multiple of 10 μm.

In order to prevent that the constituent 32 of the glass fiber filter medium 24 can escape from the outlet 18 of the filter system 10, the filter housing 12 comprises a sintered body 34. The sintered body 34 is arranged fluidically downstream of the first filter element 14. In the present case, the sintered body 34 is integrated into the filter housing 12. The sintered body 34 is substantially embodied rotation-symmetrical to its longitudinal axis and can be flowed through in the direction of its longitudinal axis.

FIG. 2 shows a second filter element 36 according to the invention. The second filter element 36 comprises a first end plate 38 in which a glass fiber filter medium 40 is embedded. The second filter element 36 has moreover a second end plate 42. The sintered body 44 is integrated into the second end plate 42. The sintered body 44 is substantially identical to the sintered body 34 (see FIG. 1). The sintered body 44 can be flowed through in the direction of its longitudinal axis.

FIG. 3 shows a strongly enlarged detail 46 of the sintered body 34 of FIG. 1. From FIG. 3 it is evident that the sintered body 34 comprises a plurality of sintering beads; for reasons of clarity, of the sintering beads only a first sintering bead 48, a second sintering bead 50, and a third sintering bead 42 are provided with reference characters. During manufacture of the sintered body 34, the sintering beads have been partially compressed and/or fused with each other.

The first sintering bead 48 is part of a first layer of sintering beads which is illustrated as the uppermost layer in FIG. 3.

The second sintering bead 50 is part of a second layer of sintering beads which is illustrated in FIG. 3 as a layer underneath the first layer. The third sintering bead 52 is part of a third layer of sintering beads which is located under the second layer. The second layer of sintering beads is thus located on the third layer of sintering beads and the first layer of sintering beads on the second layer of sintering beads. The layers are arranged on top of each other relative to the direction of flow of the sintered body 34. The layers in this context are staggered relative to each other transverse to the flow direction, i.e., the sintering beads of two layers that are adjoining each other are arranged offset to each other, respectively. The pores of the sintered body 34 are therefore staggered relative to each other transverse to the flow direction. Even though the pores, relative to the average diameter of the glass fiber particles to be retained, are relatively large, a rigid constituent 32 (see FIG. 1) of the glass fiber filter medium 24 cannot pass through the sintered body 34. The rigid constituent 32 due to its inherent bending stiffness, even at high flow rate of the fluid to be filtered, cannot be deformed in such a way that it can pass the staggered pores of the individual sintered body layers.

In summarizing, the invention concerns a filter system with a filter element and a glass fiber filter medium. Moreover, the filter system comprises a sintered body that prevents that accidentally detached constituents of the glass fiber filter medium escape from the filter system. For this purpose, the sintered body comprises passages, i.e., pores, that are preferably staggered relative to each other transverse to the flow direction of the sintered body so that the constituents of the glass fiber filter medium become wedged in the pores of the sintered body. The passage openings can have an average clearance of more than 10 μm, in particular of more than 20 μm, preferably of more than 30 μm, and particularly preferred of more than 40 μm in order to keep the flow resistance of the sintered body minimal. A sintered body can be arranged in the filter element and/or outside of the filter element in the filter system. The invention concerns moreover a filter element with a glass fiber filter medium and a sintered body arranged fluidically downstream of the glass fiber filter medium.

While specific embodiments of the invention have been shown and described in detail to illustrate the inventive principles, it will be understood that the invention may be embodied otherwise without departing from such principles.

What is claimed is:

1. A filter system for filtering a fluid, the filter system comprising:
a filter housing;
a filter element arranged in the filter housing and comprising a glass fiber filter medium;
a sintered body arranged fluidically downstream of the glass fiber filter medium for retaining constituents of the glass fiber filter medium entrained in a fluid to be filtered.

2. The filter system according to claim 1, wherein a pore size of the sintered body is greater than a cross-section of the constituents of the glass fiber filter medium.

3. The filter system according to claim 1, wherein the sintered body is flowed through in a direction of a longitudinal axis of the sintered body and/or transverse to the longitudinal axis.

4. The filter system according to claim 1, wherein the sintered body is comprised of a plastic material or a plastic material mix.

5. The filter system according to claim 1, wherein the sintered body comprises sintering beads.

6. The filter system according to claim 5, wherein the sintered body has a thickness measured in a flow direction of the fluid to be filtered through the sintered body and wherein the thickness is greater than three times an average diameter of the sintering beads.

7. The filter system according to claim 6, wherein the thickness is greater than four times the average diameter of the sintering beads.

8. The filter system according to claim 7, wherein the thickness is greater than five times the average diameter of the sintering beads.

9. The filter system according to claim 8, wherein the thickness is greater than six times the average diameter of the sintering beads.

10. The filter system according to claim 1, wherein the sintered body is integrated into the filter housing.

11. The filter system according to claim 1, wherein the sintered body is integrated into the filter element.

12. The filter system according to claim 11, wherein the filter element comprises an end disk and wherein the sintered body is integrated into the end disk.

13. A filter element for filtering a fluid to be filtered, the filter element comprising a glass fiber filter medium and a sintered body arranged fluidically downstream of the glass fiber filter medium for retaining constituents of the glass fiber filter medium entrained in the fluid to be filtered.
